(19) United States
(12) Patent Application Publication
(10) Pub. No.: US 2007/0219338 A1
(43) Pub. Date: Sep. 20, 2007

(54) Self-assembling polymer film material, self-assembled pattern, and pattern forming method

(75) Inventors: Takanobu Takeda, Joetsu-shi (JP); Osamu Watanabe, Joetsu-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/717,136

(22) Filed: Mar. 13, 2007

(30) Foreign Application Priority Data
Mar. 14, 2006 (JP) 2006-069055

(51) Int. Cl. C08G 63/00

(52) U.S. Cl. 528/190

(57) ABSTRACT

A self-assembling polymer film material comprising a polymer comprising recurring hydroxystyrene units and having a Mw of up to 20,000 is provided. When a polymer comprising hydroxystyrene units is used in the form of a block copolymer or a blend with another polymer, the material is capable of self-assembling to form a pattern of microdomain structure having a size of up to 20 nm that is difficult to achieve with prior art block copolymers.

### CROSS-REFERENCE TO RELATED APPLICATION

This non-provisional application claims priority under 35 U.S.C. §119(a) on Patent Application No. 2006-069055 filed in Japan on Mar. 14, 2006, the entire contents of which are hereby incorporated by reference.

### TECHNICAL FIELD

This invention relates to a self-assembling polymer film material, a self-assembled pattern, and a pattern forming method. More particularly, it relates to a self-assembling polymer film material in which a polymer comprising hydroxystyrene units is used in the form of a block copolymer or a blend with another polymer, which is capable of self-assembling to form a pattern of microdomain structure having a size of up to 20 nm that is difficult to achieve with prior art block copolymers, and which is suited for use as micropatterning material for VLSI fabrication or the like.

### BACKGROUND ART

In the drive for higher integration and operating speeds in LSI devices, the pattern rule is made drastically finer. The modern microprocessing techniques which have been developed thus far include ArF exposure, EB direct writing, and EUV lithography. The ArF exposure and EB direct writing lithographies have an ability to process to a size of 0.06 μm or even smaller, and can form patterns having sidewalls substantially perpendicular to the substrate when a low light absorptive resist material is used. However, the currently used lithography is difficult to form a micropattern with a size of up to 30 nm, and especially up to 10 nm.

Recently, engineers succeeded in forming ordered patterns using the block copolymer self-assembling technology rather than the lithography, as described in JP-A 2005-7244, JP-A 2005-8701, and JP-A 2005-8882. The self-assembling technology is also employed for improving the outcoupling efficiency of light-emitting diodes (JP-A 2003-218383).

However, the pattern size attainable with these self-assembling materials ranges from 50 nm to 200 nm, and down to about 30 nm at the minimum. Many problems are left with respect to the uniform and ordered array of pattern profile. The technology has not reached the practical level. There is a desire to ameliorate these problems.

### DISCLOSURE OF THE INVENTION

An object of the invention is to provide a self-assembling polymer film material in which a polymer comprising hydroxystyrene units is used in a block copolymer form or as a blend with another polymer, which is capable of self-assembling to form a pattern of microdomain structure having a size of up to 20 nm that is difficult to achieve with prior art block copolymers, and which is suited for use as micropatterning material for VLSI fabrication. Another object of the invention is to provide a self-assembled pattern and a pattern forming method.

The inventors have found that when a polymer comprising hydroxystyrene units and having a weight average molecular weight of up to 20,000, as prepared by the method to be described later, is dissolved in an organic solvent, coated onto a substrate, baked and annealed, a pattern of microdomain structure forms through a self-assembly mechanism; and that by suitable treatment such as etching, a nanostructure or a raised and recessed pattern can be formed therefrom. This self-assembling polymer film material is advantageous for precise micropatterning, and very useful as a material for VLSI microfabrication.

Specifically, the polymer of the invention is a polymer comprising hydroxystyrene units and having a weight average molecular weight of up to 20,000. Most styrene polymers used in the prior art self-assembling application have a molecular weight in excess of 20,000 because polymers having lower molecular weights do not induce self-assembly. On the other hand, the pattern size of microdomain structures resulting from self-assembly is proportional to the molecular weight of a particular polymer used. If the molecular weight exceeds 20,000, it is theoretically difficult to reduce the pattern size to 20 nm or smaller.

It has been found that as opposed to the prior art self-assembling materials of the above-described nature, a polymer comprising hydroxystyrene units and having a weight average molecular weight of up to 20,000, even in the form of a block copolymer having a molecular weight of about 10,000, induces self-assembly due to hydrogen bond-like interaction inherent to hydroxy groups on the polymer itself. That is, using the above-described polymer with a self-assembling ability, a pattern of microdomain structure having a size equal to or less than 20 nm, and even equal to or less than 10 nm can be formed.

According to the invention, there is provided a self-assembling polymer film material comprising a polymer comprising recurring hydroxystyrene units and having a weight average molecular weight of up to 20,000, the material self-assembling to form a pattern of microdomain structure having a size of up to 20 nm.

In a preferred embodiment, the hydroxystyrene units have the general formula (1):

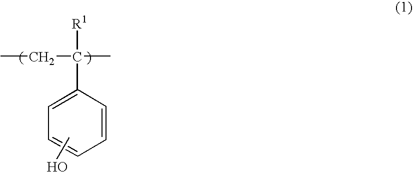

wherein R¹ is hydrogen or methyl.

In a preferred embodiment, the polymer is a block copolymer comprising recurring units having the general formula (1):

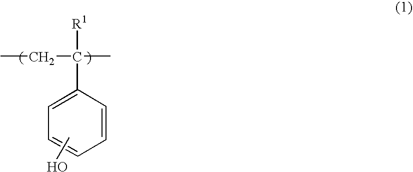

wherein R¹ is as defined above, and other recurring units.

In another preferred embodiment, the polymer is a triblock copolymer comprising recurring units having the general formula (1):

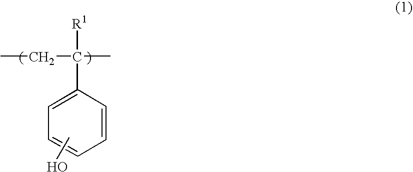

wherein R¹ is as defined above, and other recurring units.

In a further preferred embodiment, the polymer is a di- or tri-block copolymer comprising recurring units having the general formula (1):

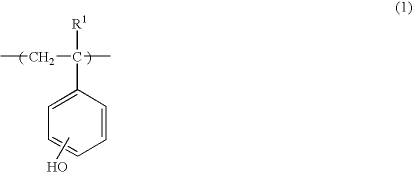

wherein R¹ is as defined above, and recurring units having the general formula (2):

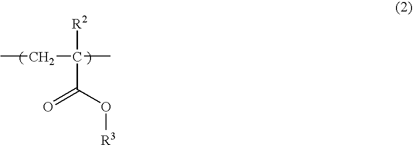

wherein R² is hydrogen, methyl or trifluoromethyl, and R³ is hydrogen, or an alkyl, hydroxy-substituted alkyl, fluorinated alkyl or fluorinated hydroxyalkyl group of 1 to 30 carbon atoms.

In a still further preferred embodiment, the polymer is a di- or tri-block copolymer comprising recurring units having the general formula (1):

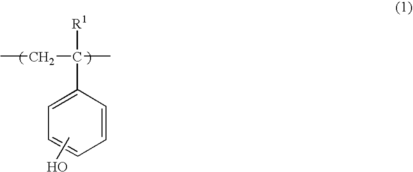

wherein R¹ is as defined above, and recurring units having the general formula (3):

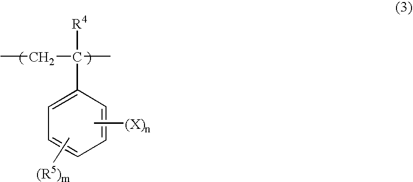

wherein R⁴ is hydrogen, methyl or trifluoromethyl, R⁵ is hydrogen, or an alkyl, alkoxyalkyl, fluorinated alkyl or fluorinated hydroxyalkyl group of 1 to 5 carbon atoms, X is fluorine, chlorine or bromine, n and m each are 0 or a positive integer of 1 to 5.

In another aspect, the invention provides a self-assembling polymer film material comprising a polymer comprising recurring units having the general formula (1):

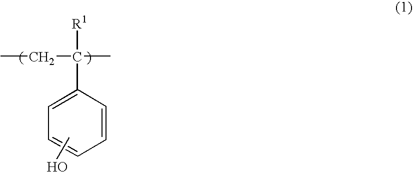

wherein R¹ is hydrogen or methyl and having a weight average molecular weight of up to 20,000, and a polymer comprising recurring units having the general formula (2):

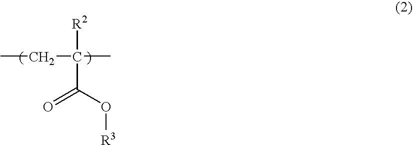

wherein R² is hydrogen, methyl or trifluoromethyl, and R³ is hydrogen, or an alkyl, hydroxy-substituted alkyl, fluorinated alkyl or fluorinated hydroxyalkyl group of 1 to 30 carbon atoms and having a weight average molecular weight of up to 20,000, said material self-assembling to form a pattern of microdomain structure having a size of up to 20 nm.

In a further aspect, the invention provides a pattern formed by self-assembly of the self-assembling polymer film material described above, and having a microdomain structure with a size of up to 20 nm. The size is preferably up to 10 nm.

In a still further aspect, the invention provides a pattern forming method comprising the step of etching the pattern described above for removing part from the microdomain structure to form a nanostructure.

### BENEFITS OF THE INVENTION

When a polymer comprising hydroxystyrene units is used in a block copolymer form or as a blend with another polymer, the resulting self-assembling polymer film material is capable of self-assembling to form a pattern of microdomain structure having a size of equal to or less than 20 nm that is difficult to achieve with prior art block copolymers. The material is thus suited for use as micropatterning material for VLSI fabrication or the like.

### DESCRIPTION OF THE PREFERRED EMBODIMENT

The self-assembling polymer film material of the invention comprises a polymer comprising recurring hydroxystyrene units, especially recurring units of the general formula (1):

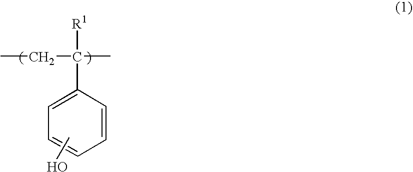

wherein R¹ is a hydrogen atom or methyl group.

The preferred polymer is a block copolymer comprising recurring units of formula (1) and other recurring units, more preferably a diblock or triblock copolymer comprising recurring units of formula (1) and other recurring units.

The other recurring units are preferably of the general formula (2) or (3).

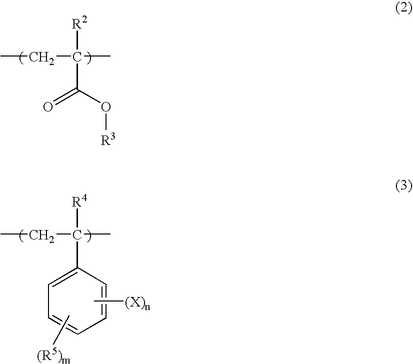

### In formula (2), R² is a hydrogen atom, methyl group or trifluoromethyl group, and R³ is a hydrogen atom, or an alkyl, hydroxy-substituted alkyl, fluorinated alkyl or fluorinated hydroxyalkyl group of 1 to 30 carbon atoms.

For R³, preferred examples of the C₁-C₃₀ alkyl group include methyl, ethyl, and t-butyl. A typical hydroxy-substituted alkyl group is hydroxyethyl. Suitable fluorinated alkyl and fluorinated hydroxyalkyl groups include the structural formulae shown below.

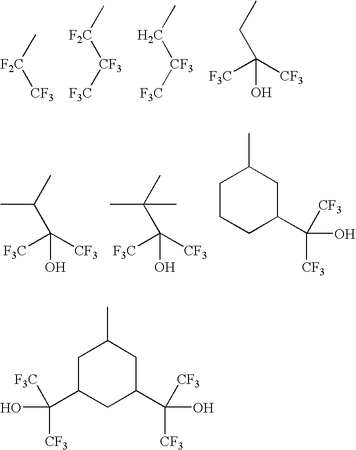

In formula (3), R⁴ is a hydrogen atom, methyl group or trifluoromethyl group, R⁵ is a hydrogen atom, or an alkyl, alkoxyalkyl, fluorinated alkyl or fluorinated hydroxyalkyl group of 1 to 5 carbon atoms, X is a fluorine, chlorine or bromine atom, n and m each are 0 or a positive integer of 1 to 5.

For R⁵, examples of the alkoxyalkyl group include methoxy, t-butoxy, and 1,1-dimethylethyloxy. A typical fluorinated alkyl group is trifluoromethyl. A typical fluorinated hydroxyalkyl group is 1,1-ditrifluoromethylhydroxymethyl.

In the embodiment wherein the polymer comprises recurring units of formula (1) and recurring units of formula (2), a proportion of the recurring units of formula (1) and the recurring units of formula (1) is preferably 20 to 80% by weight for each.

In the other embodiment wherein the polymer comprises recurring units of formula (1) and recurring units of formula (3), a proportion of the recurring units of formula (1) and the recurring units of formula (3) is preferably 20 to 80% by weight for each.

In the self-assembling polymer film material, a mixture of a polymer comprising recurring units of formula (1) and a polymer comprising recurring units of formula (2) may be used as the polymer. In this embodiment, a proportion of the polymer comprising recurring units of formula (1) and the polymer comprising recurring units of formula (2) is preferably 10 to 90% by weight for each.

Polymerization modes for producing the polymer include living anion polymerization, cationic polymerization, living radical polymerization, and coordination polymerization in the presence of organometallic catalysts. Inter alia, anionic polymerization allowing for living polymerization is preferred. For example, living anion polymerization is carried out using dry monomers and a solvent. Examples of the organic solvent used herein include hexane, cyclohexane, toluene, benzene, diethyl ether, and tetrahydrofuran. An amount of anion species is added to the organic solvent, after which the monomer(s) is added thereto for polymerization. The anion species used herein are typically organometallic compounds, examples of which include alkyllithium, alkylmagnesium halide, naphthalene sodium, and alkylated lanthanoid compounds. Inter alia, butyllithium and butylmagnesium chloride are preferred when the monomers subject to polymerization are substituted styrenes, acrylates, or methacrylates. The polymerization temperature is preferably in a range of −100° C. to 30° C., and more preferably in a range of −80° C. to 10° C. for ease of polymerization control.

One exemplary method of producing polymers according to the invention is the synthesis of a block copolymer through living anion polymerization as described above. When block copolymerization is effected using a monomer as typified by 4-ethoxyethoxystyrene, the resulting polymer is deprotected in the presence of an acid catalyst whereby a polymer having phenolic hydroxyl groups can be synthesized. Other suitable protective groups for phenolic hydroxyl groups during polymerization are t-butyl, trialkylsilyl and alkylcarbonyl groups. Also, when a polymer comprising units having another ether site or ester site is to be copolymerized, phenolic hydroxyl groups may be selectively generated by adjustment of the acid strength during deprotection reaction or by deprotection reaction under alkaline conditions.

The polymer according to the invention has a weight average molecular weight (Mw) of 1,000 to 20,000, preferably 3,000 to 15,000, and more preferably 5,000 to 12,000, as determined by gel permeation chromatography (GPC) versus polystyrene standards. With too low a Mw, a self-assembling phenomenon does not occur. With too high a Mw, the resulting pattern has a larger size.

A polymer having a broad polydispersity (Mw/Mn, molecular weight distribution) contains low and high molecular weight polymer fractions which can adversely affect the performance, i.e., exacerbate the uniformity and order of a microdomain structure pattern formed by self-assembling. For this reason, the polymer should preferably have a narrow polydispersity of 1.0 to 1.3, and more preferably 1.0 to 1.2.

In the self-assembling polymer film material, the polymer is typically dissolved in an organic solvent. Examples of the organic solvent include, but are not limited to, butyl acetate, amyl acetate, cyclohexyl acetate, 3-methoxybutyl acetate, methyl ethyl ketone, methyl amyl ketone, cyclohexanone, cyclopentanone, 3-ethoxyethyl propionate, 3-ethoxymethyl propionate, 3-methoxymethyl propionate, methyl acetoacetate, ethyl acetoacetate, diacetone alcohol, methyl pyruvate, ethyl pyruvate, propylene glycol monomethyl ether, propylene glycol monoethyl ether, propylene glycol monomethyl ether propionate, propylene glycol monoethyl ether propionate, ethylene glycol monomethyl ether, ethylene glycol monoethyl ether, diethylene glycol monomethyl ether, diethylene glycol monoethyl ether, 3-methyl-3-methoxybutanol, N-methylpyrrolidone, dimethyl sulfoxide, γ-butyrolactone, propylene glycol methyl ether acetate (PGMEA), propylene glycol ethyl ether acetate, propylene glycol propyl ether acetate, methyl lactate, ethyl lactate, propyl lactate, and tetramethylenesulfone. Of these, propylene glycol alkyl ether acetates and alkyl lactates are preferred. These solvents may be used alone or in admixture.

Suitable propylene glycol alkyl ether acetates include those having an alkyl moiety of 1 to 4 carbon atoms, for example, methyl, ethyl or propyl, with methyl and ethyl being preferred. The propylene glycol alkyl ether acetates include 1,2- and 1,3-substituted forms, so that three isomers exist depending on a combination of substitution sites. Either a single isomer or a mixture of isomers may be used. Suitable alkyl lactates include those having an alkyl moiety of 1 to 4 carbon atoms, for example, methyl, ethyl or propyl, with methyl and ethyl being preferred.

When the propylene glycol alkyl ether acetate is used, it preferably accounts for at least 50% by weight of the total solvent. When the alkyl lactate is used, it preferably accounts for at least 50% by weight of the total solvent. When a mixture of the propylene glycol alkyl ether acetate and the alkyl lactate is used, the mixture preferably accounts for at least 50% by weight of the total solvent. More preferably, the propylene glycol alkyl ether acetate and the alkyl lactate are mixed in a proportion of 60 to 95% by weight and 5 to 40% by weight, respectively. Outside the range, a less proportion of the propylene glycol alkyl ether acetate may raise problems such as inefficient coating whereas a larger proportion may raise problems such as insufficient dissolution.

Usually, the solvent is used in an amount of 300 to 8,000 parts by weight, preferably 400 to 3,000 parts by weight per 100 parts by weight of the polymer solids. The concentration is not limited to this range as long as it is compatible with the existing coating methods.

To the self-assembling polymer film material, a surfactant may be added for improving coating characteristics. Examples of the surfactant include, but are not limited to, nonionic surfactants, for example, polyoxyethylene alkyl ethers such as polyoxyethylene lauryl ether, polyoxyethylene stearyl ether, polyoxyethylene cetyl ether, and polyoxyethylene olein ether; polyoxyethylene alkyl aryl ethers such as polyoxyethylene octyl phenol ether and polyoxyethylene nonyl phenol ether; polyoxyethylene polyoxypropylene block copolymers; sorbitan fatty acid esters such as sorbitan monolaurate, sorbitan monopalmitate, and sorbitan monostearate; polyoxyethylene sorbitan fatty acid esters such as polyoxyethylene sorbitan monolaurate, polyoxyethylene sorbitan monopalmitate, polyoxyethylene sorbitan monostearate, polyoxyethylene sorbitan trioleate, polyoxyethylene sorbitan tristearate; fluorochemical surfactants such as EFTOP EF301, EF303 and EF352 (Tohkem Products Co., Ltd.), Megaface F171, F172 and F173 (Dainippon Ink & Chemicals, Inc.), Fluorad FC430 and FC431 (Sumitomo 3M Co., Ltd.), Aashiguard AG710, Surflon S-381, S-382, SC101, SC1O2, SC103, SC104, SC105, SC106, Surfynol E1004, KH-10, KH-20, KH-30 and KH-40 (Asahi Glass Co., Ltd.); organosiloxane polymers KP341, X-70-092 and X-70-093 (Shin-Etsu Chemical Co., Ltd.), acrylic acid or methacrylic acid Polyflow No. 75 and No. 95 (Kyoeisha Ushi Kagaku Kogyo K.K.). Inter alia, Fluorad FC430, Surflon S-381, Surfynol E1004, KH-20 and KH-30 are preferred. These surfactants may be used alone or in admixture.

In the self-assembling polymer film material, the surfactant is preferably added in an amount of up to 2 parts, and especially up to 1 part by weight, per 100 parts by weight of the polymer solids. The lower limit is preferably at least 0.1 part by weight, though not critical.

The self-assembling polymer film material of the invention is coated onto a substrate such as a silicon substrate, preferably to a build-up of 0.005 to 0.05 μm, more preferably 0.01 to 0.03 μm, and baked and annealed at 100 to 300° C., preferably 100 to 150° C., for 5 to 600 minutes, preferably 5 to 100 minutes. Then a pattern of microdomain structure having a size of up to 20 nm, preferably up to 10 nm forms by self-assembly.

The pattern may then be treated as by etching with a halogen gas, O₂ gas, SO₂ gas or the like, whereby part of the microdomain structure is removed, resulting in an irregular nanostructure.

### EXAMPLE

Synthesis Examples, Comparative Synthesis Examples, Examples, and Comparative Examples are given below by way of illustration and not by way of limitation. The average molecular weights including weight average molecular weight (Mw) and number average molecular weight (Mn) are determined by gel permeation chromatography (GPC) versus polystyrene standards. Mw/Mn is polydispersity. PGMEA is propylene glycol methyl ether acetate.

### Synthesis Example 1

To a 2-L flask which had been vacuum dried, 1500 g of tetrahydrofuran which had been dehydrated by distillation was fed in a nitrogen atmosphere and cooled at −75° C. Then 12.3 g of s-butyllithium (1N cyclohexane solution) was admitted, and 161 g of 4-ethoxyethoxystyrene which had been dehydrated by distillation was added dropwise at such a controlled rate that the temperature of the reaction solution might be kept below −60° C. Reaction occurred for 15 minutes. Then 98.7 g of 4-t-butoxystyrene which had been dehydrated by distillation was added dropwise, after which reaction occurred for 30 minutes. Then 10 g of methanol was added to quench the reaction. The reaction solution was allowed to warm up to room temperature and concentrated in vacuum. Methanol, 800 g, was added to the concentrate, which was stirred and allowed to stand, after which the upper layer, methanol phase was separated off. This operation was repeated three times until the metal Li was removed. The lower layer, polymer solution was concentrated, to which were added 580 g of tetrahydrofuran, 507 g of methanol, and 5.0 g of oxalic acid. The solution was heated at 40° C., whereupon deprotection reaction occurred for 40 hours. The reaction solution was neutralized with 3.5 g of pyridine, concentrated, dissolved in 0.6 L of acetone, and poured into 7.0 L of water for precipitation. After washing, the resulting white solids were filtered and vacuum dried at 40° C., yielding 166.2 g of a white polymer.

The polymer was analyzed by ¹³C-NMR, ¹H-NMR and GPC, with the results shown below.

Copolymer compositional ratio hydroxystyrene: 4-t-butoxystyrene=57.7:42.3

Mw=9,300

Mw/Mn=1.13

This is designated Diblock A.

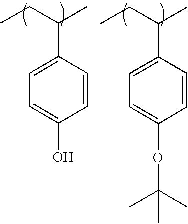

### Synthesis Example 2

To a 2-L flask which had been vacuum dried, 1500 g of tetrahydrofuran which had been dehydrated by distillation was fed in a nitrogen atmosphere and cooled at −75° C. Then 12.5 g of s-butyllithium (1N cyclohexane solution) was admitted, and 41 g of 4-t-butoxystyrene which had been dehydrated by distillation was added dropwise at such a controlled rate that the temperature of the reaction solution might be kept below −60° C. Reaction occurred for 15 minutes. Then 154 g of 4-ethoxyethoxystyrene which had been dehydrated by distillation was added dropwise, after which reaction occurred for 15 minutes. Finally, 41 g of 4-t-butoxystyrene which had been dehydrated by distillation was added dropwise again, after which reaction occurred for 30 minutes. Then 10 g of methanol was added to quench the reaction. The reaction solution was allowed to warm up to room temperature and concentrated in vacuum. Methanol, 800 g, was added to the concentrate, which was stirred and allowed to stand, after which the upper layer, methanol phase was separated off. This operation was repeated three times until the metal Li was removed. The lower layer, polymer solution was concentrated, to which were added 580 g of tetrahydrofuran, 507 g of methanol, and 5.0 g of oxalic acid. The solution was heated at 40° C., whereupon deprotection reaction occurred for 40 hours. The reaction solution was neutralized with 3.5 g of pyridine, concentrated, dissolved in 0.6 L of acetone, and poured into 7.0 L of water for precipitation. After washing, the resulting white solids were filtered and vacuum dried at 400C, yielding 163.2 g of a white polymer.

The polymer was analyzed by ¹³C-NMR, ¹H-NMR and GPC, with the results shown below.

Copolymer compositional ratio hydroxystyrene: 4-t-butoxystyrene=62.5:37.5

Mw=10,200

Mw/Mn=1.09

This is designated Triblock B.

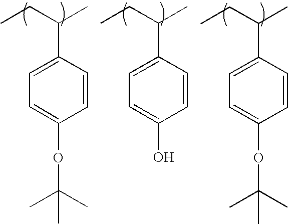

### Synthesis Example 3

To a 2-L flask which had been vacuum dried, 1500 g of tetrahydrofuran which had been dehydrated by distillation was fed in a nitrogen atmosphere and cooled at −75° C. Then 14.5 g of s-butyllithium (1N cyclohexane solution) was admitted, and 193 g of 4-ethoxyethoxystyrene which had been dehydrated by distillation was added dropwise at such a controlled rate that the temperature of the reaction solution might be kept below −60° C. Reaction occurred for 15 minutes. Then 47 g of methyl methacrylate which had been dehydrated by distillation was added dropwise. The reaction solution was warmed to 0° C. over 30 minutes while reaction occurred. Then 10 g of methanol was added to quench the reaction. The reaction solution was allowed to warm up to room temperature and concentrated in vacuum. Methanol, 800 g, was added to the concentrate, which was stirred and allowed to stand, after which the upper layer, methanol phase was separated off. This operation was repeated three times until the metal Li was removed. The lower layer, polymer solution was concentrated, to which were added 580 g of tetrahydrofuran, 507 g of methanol, and 5.0 g of oxalic acid. The solution was heated at 40° C., whereupon deprotection reaction occurred for 40 hours. The reaction solution was neutralized with 3.5 g of pyridine, concentrated, dissolved in 0.6 L of acetone, and poured into 7.0 L of water for precipitation. After washing, the resulting white solids were filtered and vacuum dried at 40° C., yielding 148.9 g of a white polymer.

The polymer was analyzed by ¹³C-NMR, ¹H-NMR and GPC, with the results shown below.

Copolymer compositional ratio hydroxystyrene: methyl methacrylate=67.9:32.1

Mw=11,200

Mw/Mn=1.12

This is designated Diblock C.

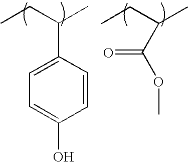

By the same synthesis procedure as above, polymers, Triblock D, Diblocks E and F having the following structural formulae were synthesized.

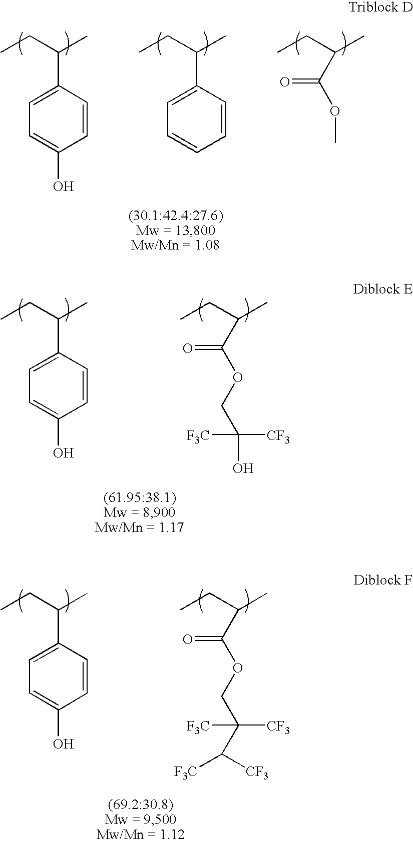

For comparison purposes, polymers, Diblocks G, H and I having the following structural formulae were synthesized.

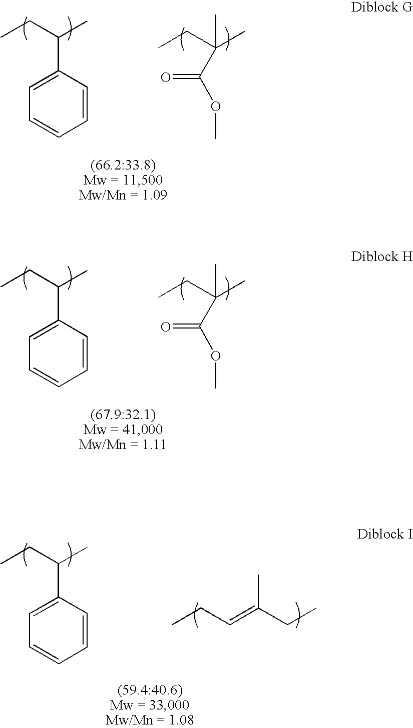

### Examples and Comparative Examples

A solution of each of di- or tri-block polymers A to I in PGMEA at a concentration of 50 to 70% by weight was admitted into a sample holder of 2 mm square. Using the small-angle X-ray scattering (SAXS) station of synchrotron radiation beam line BL45XU, SPring-8 (super photon ring 8 GeV) in High Energy Accelerator Research Organization of Japan, the polymer solution was measured for q (nm⁻¹). On Fourier transform analysis, the average pattern size (width D) of the microdomain structure resulting from self-assembling of the polymer was determined. The results are shown in Table 1.

TABLE 1

| | | D = microdomain |
|---|---|---|
| | | structure |
| | Polymer | width (nm) |
| Example 1 | Diblock A | 15.1 |
| Example 2 | Triblock B | 8.43 |
| Example 3 | Diblock C | 16.6 |
| Example 4 | Triblock D | 18.2 |
| Example 5 | Diblock E | 8.8 |
| Example 6 | Diblock F | 8.7 |
| Comparative Example 1 | Diblock G | not self-assembled or |
| | | microphase separated |
| Comparative Example 2 | Diblock H | 47.6 |
| Comparative Example 3 | Diblock I | 24.8 |

If the PGMEA solution of the block polymer in each Example is coated onto a silicon substrate and annealed at 50 to 400° C. for 10 minutes to 50 hours, a pattern of microdomain structure can form on the substrate by self-assembly. If the pattern of microdomain structure is etched, a nanostructure or a raised and recessed pattern such as a nano-dot pattern or line pattern can be formed.

Japanese Patent Application No. 2006-069055 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A self-assembling polymer film material comprising a polymer comprising recurring hydroxystyrene units and having a weight average molecular weight of up to 20,000, the material self-assembling to form a pattern of microdomain structure having a size of up to 20 nm.

2. The self-assembling polymer film material of claim 1, wherein the hydroxystyrene units have the general formula 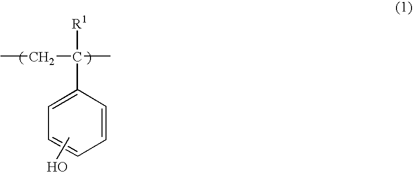
wherein R¹ is hydrogen or methyl.

3. The self-assembling polymer film material of claim 1, wherein the polymer is a block copolymer comprising recurring units having the general formula (1): 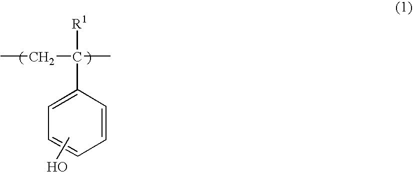
wherein R¹ is hydrogen or methyl and further comprising other recurring units.

4. The self-assembling polymer film material of claim 1, wherein the polymer is a triblock copolymer comprising recurring units having the general formula (1): 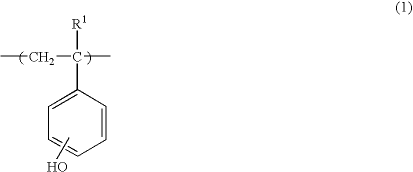
wherein R¹ is hydrogen or methyl and further comprising other recurring units.

5. The self-assembling polymer film material of claim 1, wherein the polymer is a di- or tri-block copolymer comprising recurring units having the general formula (1): 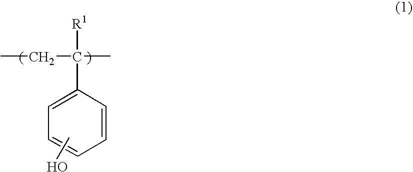
wherein R¹ is hydrogen or methyl and further comprising recurring units having the general formula (2): 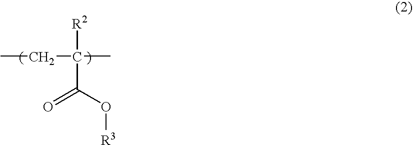
wherein R² is hydrogen, methyl or trifluoromethyl, and R³ is hydrogen, or an alkyl, hydroxy-substituted alkyl, fluorinated alkyl or fluorinated hydroxyalkyl group of 1 to 30 carbon atoms.

6. The self-assembling polymer film material of claim 1, wherein the polymer is a di- or tri-block copolymer comprising recurring units having the general formula (1): 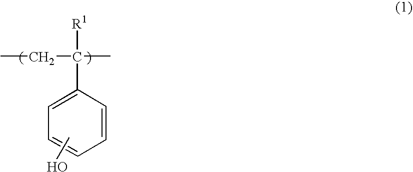
wherein R¹ is hydrogen or methyl and further comprising recurring units having the general formula (3): 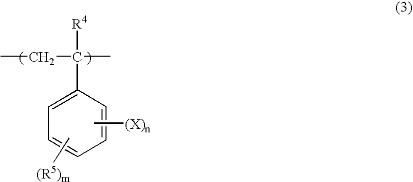
wherein R⁴ is hydrogen, methyl or trifluoromethyl, R⁵ is hydrogen, or an alkyl, alkoxyalkyl, fluorinated alkyl or fluorinated hydroxyalkyl group of 1 to 5 carbon atoms, X is fluorine, chlorine or bromine, n and m each are 0 or a positive integer of 1 to 5.

7. A self-assembling polymer film material comprising
a polymer comprising recurring units having the general formula (1): 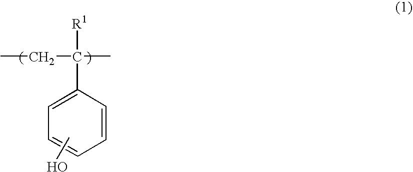
wherein R¹ is hydrogen or methyl and having a weight average molecular weight of up to 20,000, and
a polymer comprising recurring units having the general formula (2): 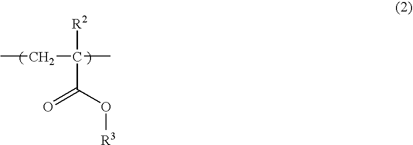
wherein R² is hydrogen, methyl or trifluoromethyl, and R³ is hydrogen, or an alkyl, hydroxy-substituted alkyl, fluorinated alkyl or fluorinated hydroxyalkyl group of 1 to 30 carbon atoms and having a weight average molecular weight of up to 20,000,
said material self-assembling to form a pattern of microdomain structure having a size of up to 20 nm.

8. A pattern formed by self-assembly of the self-assembling polymer film material comprising a polymer comprising recurring hydroxystyrene units and having a weight average molecular weight of up to 20,000, said pattern and having a microdomain structure with a size of up to 20 nm.

9. The pattern of claim 8, wherein the size is up to 10 nm.

10. A pattern forming method comprising etching the pattern of claim 8, for removing part from the microdomain structure to form a nanostructure.

11. The pattern of claim 8, wherein the polymer further comprises recurring units having the general fornnda (2) 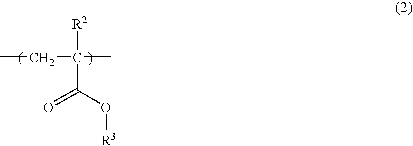
whercun R² is hydrogen, methyl or trifluoromethyl, and R³ is hydrogen, or an alkyl, hydroxy-substituted aikyl. fluorinated alkyl or fluorinated hydroxyalkyl group of 1 to 30 carbon atoms.

12. The pattern of claim 8, wherein the polymer further comprises recurnug units having the general formula (3): 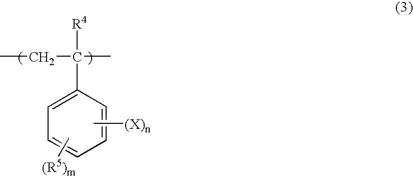
wherein R⁴ is hydrogen, methyl or trifluoromethyl, R⁵ is hydrogen, or an aikyl, alkoxyalkyl, fluorinated alkyl or fluorinated hydroxyalkyl group of 1 to 5 carbon atoms, X is fluorine, chlorine or bromine, and n and m each are 0 or a positive integer of 1 to 5.
